(19) United States
(12) Patent Application Publication
(10) Pub. No.: US 2006/0225597 A1
(43) Pub. Date: Oct. 12, 2006

(54) Printed T-shirt and method and apparatus for merchandising the same

(76) Inventors: Jay J. Cohen, Atlanta, GA (US); John S. Cohen, Atlanta, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/149,736

(22) Filed: Jun. 9, 2005

Related U.S. Application Data
(60) Provisional application No. 60/669,596, filed on Apr. 8, 2005.

(51) Int. Cl. G03G 15/32

(52) U.S. Cl. 101/494

(57) ABSTRACT

A packaged, printed T-shirt including a printed T-shirt formed into a compact, box-like shape, a translucent or transparent wrapping wrapped about the printed T-shirt to hold the T-shirt in the compact, box-like shape, and a writable label affixed to the outside of the wrapping to allow the T-shirt to be readily addressed and forwarded to a recipient address. Additionally, the packaged, printed T-shirts are displayed in a display case having a plurality of basket-like holders each configured for holding at least one of the packaged T-shirts.

### CROSS REFERENCE TO RELATED APPLICATIONS

This application claims priority to U.S. Provisional Patent Application Ser. No. 60/567,942, filed Apr. 8, 2005, which is hereby incorporated herein by reference in its entirety for all purposes.

### FIELD OF THE INVENTION

The present invention relates generally to T-shirts and in particular relates to printed T-shirts and a method and apparatus for merchandising printed T-shirts.

### BACKGROUND OF THE INVENTION

One of the more common ways of displaying printed T-shirts for sale, as commonly available in souvenir shops for example, for sale is to fold the T-shirts into a rectangular shape of around 12″×15″ and then stack the shirts on display shelves. However, this approach has several drawbacks. First, many customers tend to unfold the shirts to see what exactly is printed on them and then just toss them back in a pile, so store clerks find themselves constantly refolding the T-shirts. Additionally, the folded T-shirts tend to occupy a large amount of space on the display shelves.

To reduce the amount of space needed to display a large volume of printed T-shirts, some have compressed or compacted or molded the T-shirts into smaller packages. Once compacted, the printed T-shirts are wrapped in a transparent plastic material, such as cellophane, to hold its shape. Additionally, some have even compacted T-shirts into a block and then prior to wrapping with plastic, included a label inside the plastic wrapping showing what was printed on the T-shirt. However, this arrangement is not conducive for mailing. For example, when people are vacationing, many tend to travel light and would prefer to ship souvenirs home. In order to mail the T-shirt, the purchaser of the T-shirt typically would package it in another envelope or box, would add a mailing label, or would have to find a suitable pen to write on the outside of the plastic wrapping.

There is, therefore, a need in the industry for an apparatus that allows for the merchandising of compacted T-shirts, and that solves the above-described shortcomings and other related and unrelated shortcomings.

### SUMMARY OF THE INVENTION

Briefly described, in a first preferred form the present invention is a method for merchandising printed T-shirts. The method comprises molding the printed T-shirts into a compact, three-dimensional shape. The method further includes the step of packaging the T-shirt in a wrapping to maintain the T-shirts in the compact, three-dimensional shape. The method further includes placing the packaged T-shirts in a display case having a plurality of baskets each configured for holding at least one or more of the packaged T-shirts.

Preferably, the display case is a revolving case. Preferably, the three-dimensional shape is generally brick-like or block-like. Also preferably, the method can further include affixing a mailing label to the outside of the wrapping to make it easy for a purchaser to address and mail the T-shirt without repackaging or re-wrapping the T-shirt. In one form, the mailing label can be paper. In another form, the mailing label can be vinyl. Optionally, a portion of the mailing label can bear an image representing an image printed on the T-shirt.

Furthermore, the display can be freestanding upon the floor or can be adapted and configured to be supported upon a counter or another piece of furniture. Also, the display case can be wall-mounted. Preferably, the baskets comprise wire baskets. Optionally, the baskets comprise plastic baskets which can be clear or translucent or wood or other materials as well. Preferably, the baskets have a generally open top to allow T-shirts to be removed easily therefrom.

In another form, the present invention comprises an improvement in the merchandising of printed, molded T-shirts of the type that are compressed or molded into a compact three-dimensional shape. The improvement comprises using a revolving display fixture for displaying a plurality of the compact, molded T-shirts. The display fixture has a plurality of basket-like or bucket-like compartments for holding one or more of the T-shirts.

In yet another form, the present invention comprises a packaged, printed T-shirt. The packaged printed T-shirt includes a printed T-shirt formed into a compact box-like shape. The packaged, printed T-shirt also includes a translucent or transparent wrapping wrapped about the outside of the compact, box-like shape of the T-shirt. A writable label is affixed to the outside of the wrapping to allow the T-shirt to be readily addressed and forwarded to a recipient address. Preferably, the writable label is a paper label. Alternatively, the writable label can be vinyl. Optionally, the writable label can comprise an address portion and an image portion, with the image portion bearing a representation or likeness of an image printed on the T-shirt. Preferably, the compact box-like shape has a width and height of about 3″×5″.

### BRIEF DESCRIPTION OF THE DRAWINGS

FIG.1 is a perspective view of a display case for printed T-shirts according to an illustrative form of the present invention.

FIG. 2 is a perspective view of a printed T-shirt that has been molded into a brick-like or box-like shape.

FIG. 3 is a perspective view of a display case for printed T-shirts according to yet another illustrative form of the present invention.

FIG. 4 is a perspective view of a display case for printed T-shirts according to still yet another illustrative form of the present invention.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

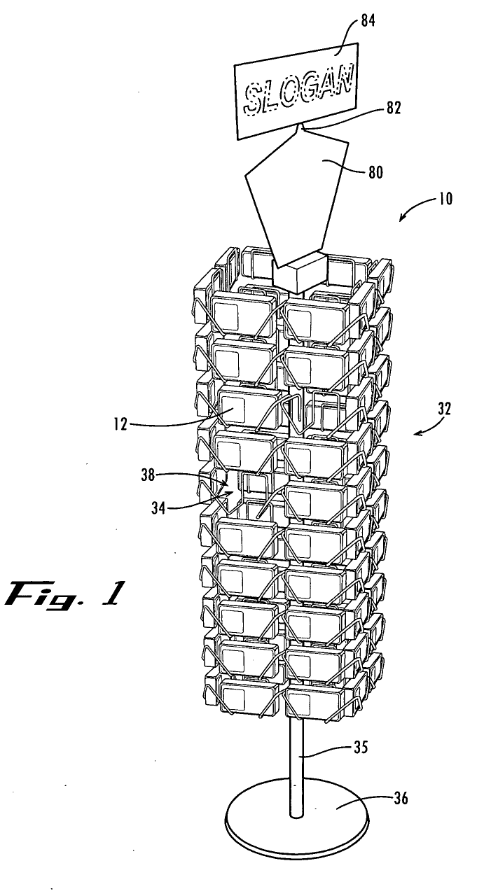

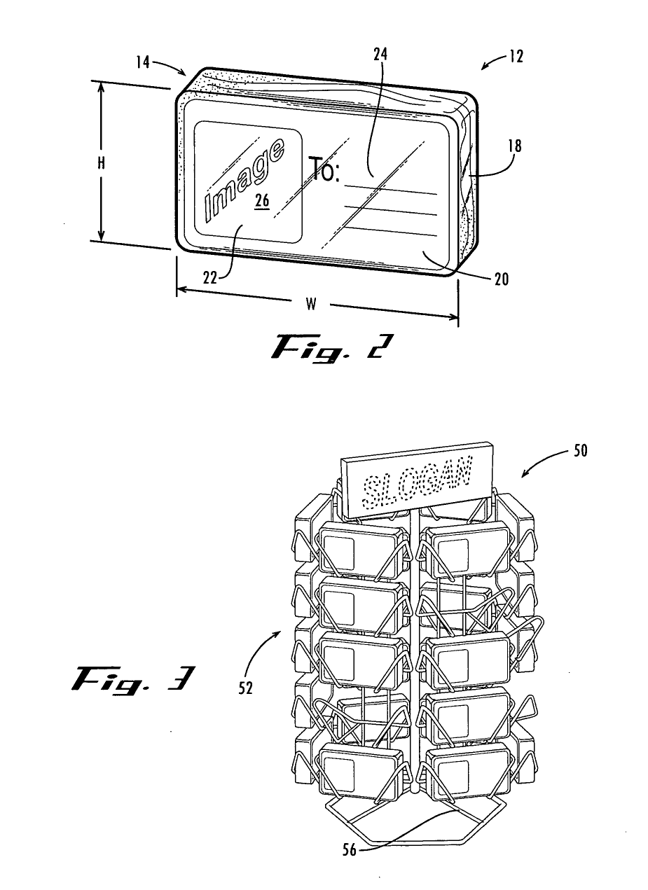

FIG. 1 is a perspective view of a T-shirt mounting display 10 according to an illustrative form of the present invention for displaying a plurality of printed T-shirts 12 that have been molded or compressed into a compact, three-dimensional shape 14. An exemplary, compact, three-dimensional shape 14 is depicted in FIG. 2. As used herein, the term “printed T-shirt” refers to a T-shirt that has some image or indicia, such as but not limited to a logo, a slogan, a company name, a sports team, or other artwork printed on it. Preferably, the three-dimensional shape 14 is generally brick-like or block-like; however, those skilled in the art will understand that the T-shirts 12 can be molded into a variety of other three-dimensional shapes, such as, but not limited to a cube-like, trapezoidal, pyramidal, spherical, or cylindrical shape. Further, the shape can be irregular or regular. Also preferably, the block-like shape has a height H of about three inches and a width W of about five inches. In such an embodiment, the T-shirts are about the size of a standard postcard, and can be displayed in a manner similar to displaying postcards.

Once shaped, each T-shirt 12 is packaged in a wrapping material 18, such as cellophane or plastic, to secure the shape. Preferably, the wrapping material 18 is transparent, semi-transparent, translucent, or semi-translucent so as to the allow a purchaser to view (or partially view) the T-shirt. Alternatively, an opaque material can be used to wrap the molded T-shirt. Optionally, the opaque material can have a window for viewing an image or indicia of what is printed on the T-shirt, or a sticker or label can be affixed to the opaque wrapping to inform the purchaser of the contents.

Preferably, each packaged T-shirt 12 has a label 20 affixed thereto with some form of adhesive. Preferably, the label 20 is a paper label that is affixed to the outside of the wrapping. The label 20 can be a mailing label placed on the outside of the wrapping so as to make it easy for a purchaser to address and mail the T-shirt without re-packaging or re-wrapping. Paper is preferable because purchasers can write on it with almost any available writing instrument, although the present invention contemplates the use of other labels, including those made of vinyl and those with a plastic or glossy finish. As depicted in FIG. 2, the label 20 has an optional image portion 22 and an address portion 24. The image portion of the label bears a representation 26 of the image or indicia printed on the T-shirt. The address portion 24 is space where the purchaser can write an address.

Referring back to FIG. 1, a display case 10 for displaying the packaged T-shirts 12 has a frame 32 for holding a plurality of basket-like or bucket-like holders or compartments 34. In the illustrated embodiment depicted, the frame 32 is a wire frame that revolves around a central axle 35 that connects to an elongated base or pedestal 36 that sits on the floor. In this embodiment, the display case 10 is freestanding and is adapted to be positioned on the floor. The basket-like holders 34 are sized and shaped to hold a packaged T-shirt that has been molded into a compact, three-dimensional shape. In the depicted embodiment of FIG. 1, each basket-like holder is a generally box-like holder for housing at least one packaged T-shirt. Preferably, each basket-like holder 34 is sized and shaped to accommodate a single packaged T-shirt 12. Optionally, each basket-holder 34 can be sized and shaped to hold a plurality of packaged T-shirts 12. Preferably, the basket-holders 34 are wire baskets. Optionally, the basket-like holders 34 can be clear plastic baskets. Alternatively, the baskets can be constructed of any durable material and configured in any manner so as to the display at least a portion of the contents of the basket. In the depicted embodiment, the basket-like holders 34 have a generally open top 38 to allow the packaged T-shirts to be easily removed therefrom. Optionally, an opening can be formed in either side of the basket to allow the T-shirts to be easily removed therefrom.

FIG. 3 depicts a display case 50 for displaying the packaged T-shirts according to another example embodiment of the present invention. The display case 50 is substantially similar to the display case 10, but with the exception that the display case 50 has a frame 52 with a short base 56 that is adapted and configured to be supported upon a counter or piece of furniture (as compared to the elongated base 36 of display case 50 that is adapted and configured to be positioned on the floor). Thus, the display case 50 is a revolving display case that can be set on a counter top.

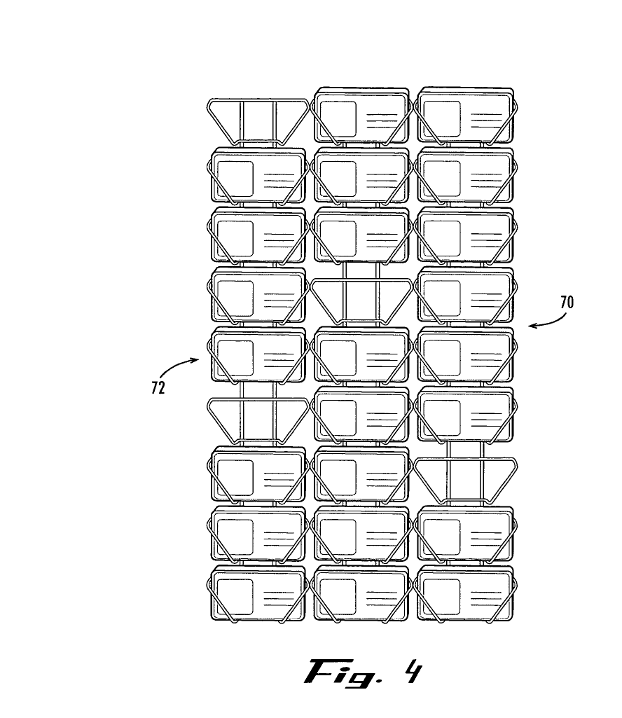

FIG. 4 depicts a display case 70 for displaying the packaged T-shirts according to yet another example embodiment of the present invention. The display case 70 is substantially similar to the display cases 10 and 50, but with the exceptions noted herein. The display case 70 has a generally planar frame 72 for mounting to a wall or a substantially upright surface with appropriate fasteners. The frame 72 can be elongated in the vertical direction, as depicted in FIG. 4, or elongated in the horizontal direction. Optionally, the frame 72 can have a height equal to its length.

Optionally, the display cases of the present invention include a shirt frame 80 as depicted in FIG. 1. Preferably, the shirt frame 80 is wire shirt frame similar to a hanger for clothing. Optionally, the shirt frame 80 can be of the form of a torso of a mannequin. The frame 80 provides a display for the T-shirt similar to as if it were being worn by a person. This allows the shopper to more easily recognize that the packages on the display rack are T-shirts for sale. Preferably the shirt frame 80 is rigidly secured to the central axle 35 of the display case 10 and does not spin as the rest of the display case is rotated. In other words, the shirt frame 80 is stationary. Alternatively, the shirt frame 80 can be mounted to the rotating portion of the display so that it rotates therewith.

The shirt frame 80 optionally includes a sign holder 82 to hold a sign 84 of what is being displayed. Preferably, the sign holder 82 includes two parallel pieces of wire or another rigid material, with an opening therebetween such that a paper or cardboard sign can be securely held therewithin.

The present invention also includes a method of merchandising T-shirts 12 in a display case of the present invention. The T-shirts 12 are molded or compressed into a compact, three-dimensional shape 14, such as a generally block-like or brick-like shape. The compressed T-shirts are packaged in a wrapping 18, such as a transparent or translucent wrapping, to maintain the T-shirts in the compact, three-dimensional shape 14. The T-shirts 12 are placed in a display case, such a revolving display case or a flat, planar display case, having a plurality of basket-like holders each configured for holding at least one of the packaged T-shirts. A writable label, such as a paper or vinyl label, can be affixed to the outside of the wrapping 18 to make it easy for a purchaser to address and mail the T-shirt 12 without re-packaging or re-wrapping. Optionally, the label can include a representation of the image or indicia printed on the T-shirt 12.

While the invention has been described with reference to preferred and example embodiments, it will be understood by those skilled in the art that a variety of modifications, additions and deletions are within the scope of the invention, as defined by the following claims.

What is claimed is:

1. A method for merchandising printed T-shirts comprising:
molding the printed T-shirts into a compact, three-dimensional shape;
packaging the T-shirts in a wrapping to maintain the T-shirts in the compact, three-dimensional shape; and
placing the packaged T-shirts in a display case having a plurality of basket-like holders each configured for holding at least one of the packaged T-shirts.

2. A method as claimed in claim 1 wherein the three-dimensional shape is generally brick-like or block-like.

3. A method as claimed in claim 1 further comprising the step of affixing a mailing label to the outside of the wrapping to make it easy for a purchaser to address and mail the T-shirt without re-packaging or re-wrapping.

4. A method as claimed in claim 3 wherein the mailing label comprises a paper label.

5. A method as claimed in claim 3 wherein a portion of the mailing label bears an image representing an image printed on the T-shirt.

6. A method as claimed in claim 1 wherein the display is a revolving, freestanding display and adapted to be positioned on the floor.

7. A method as claimed in claim 1 wherein the display is a revolving display and is adapted and configured to be supported upon a counter or piece of furniture.

8. A method as claimed in claim 1 wherein the display is generally planar and is adapted to be hung on a wall.

9. A method as claimed in claim 1 wherein the basket-like holders are wire baskets.

10. A method as claimed in claim 1 wherein the basket-like holders are clear plastic baskets.

11. A method as claimed in claim 1 wherein the basket-like holders have a generally open top to allow the T-shirts to be easily removed therefrom.

12. A method as claimed in claim 1 wherein the display case further includes a shirt frame mounted thereto, wherein the shirt frame displays a T-shirt as if it were being worn by a person.

13. In the merchandising of printed, molded T-shirts of the type being compressed or molded into a wrapped, compact three-dimensional shape, the improvement therein comprising:
using a display fixture for displaying a plurality of wrapped, molded T-shirts, the display fixture having a plurality of basket-like or bucket-like compartments for holding one or more of the T-shirts.

14. A packaged, printed T-shirt, comprising:
a printed T-shirt formed into a compact, boxlike shape;
a translucent or transparent wrapping wrapped about the printed T-shirt to hold the T-shirt in the compact, box-like shape; and
a writable label affixed to the outside of the wrapping to allow the T-shirt to be readily addressed and forwarded to a recipient address.

15. A packaged, printed T-shirt as claimed in claim 14 wherein the writable label comprises a paper label.

16. A packaged, printed T-shirt as claimed in claim 14 wherein the writable label comprises a vinyl label.

17. A packaged, printed T-shirt as claimed in claim 14 wherein the writable label comprises an address portion and an image portion, with the image portion bearing a representation of an image printed on the T-shirt.

18. A packaged, printed T-shirt as claimed in claim 14 wherein the compact boxlike shape has a width and height of about 3″×5″.
